(19) United States
(12) Patent Application Publication
(10) Pub. No.: US 2011/0231850 A1
(43) Pub. Date: Sep. 22, 2011

(54) BLOCK-BASED TRANSMISSION SCHEDULING METHODS AND SYSTEMS

(75) Inventors: Shu-Hsin Chang, Tainan City (TW); Jui-Wen Chen, Kaohsiung City (TW); Shwu-Ling Yeh, Hsinchu County (TW); Wei-Chih Ting, Taichung City (TW)

(73) Assignee: INDUSTRIAL TECHNOLOGY RESEARCH INSTITUTE, HSINCHU (TW)

(21) Appl. No.: 12/877,801

(22) Filed: Sep. 8, 2010

(30) Foreign Application Priority Data
Mar. 17, 2010 (TW) TW99107773

(51) Int. Cl. G06F 9/46

(52) U.S. Cl. 718/102

(57) ABSTRACT

Block-based transmission scheduling methods and systems are provided. First, a plurality of packets corresponding to at least one data flow is received. The packets of the data flow are accumulated to form a data block. Then, the data block of the data flow is scheduled and transmitted according to a transmission scheduling algorithm based on the unit of block. In some embodiments, when the length of the accumulated data block equals to or is greater than a predefined or dynamically calculated block length threshold, the data block is scheduled and transmitted according to the transmission scheduling algorithm. In some embodiments, when current time is equal to a specific time point derived from a dynamically calculated or a fixed time duration, the data block is scheduled and transmitted according to the transmission scheduling algorithm.

### CROSS REFERENCE TO RELATED APPLICATIONS

This Application claims priority of Taiwan Patent Application No. 99107773, filed on Mar. 17, 2010, the entirety of which is incorporated by reference herein.

### BACKGROUND

1. Technical Field

The disclosure relates generally to block-based transmission scheduling methods and systems.

2. Description of the Related Art

With the development of networks, large amounts of data must be transmitted therein via transmission devices, such as high speed switches and routers. A transmission scheduling algorithm can be designed in the transmission device to allocate network bandwidth and related resources such as memory space to fulfill required quality of service for each data flow.

Presently, there exists a trade-off between computational complexity and quality of service for scheduling algorithms. For example, when a good quality of service is required, the complexity of the scheduling algorithm must be increased. On the other hand, when the complexity of the scheduling algorithm is reduced, the quality of service provided by the scheduling algorithm degrades and is less flexible.

Generally, WFQ (Weighted Fair Queuing) is a scheduling algorithm with a very good quality of service. The quality of service for WFQ theoretically approaches to that of an ideal system called FFQ (Fluid Fair Queuing). WFQ and its derived algorithms are superior to other algorithms in various properties, such as fairness, maximum delay, maximum latency, and requirement of temporary storage space for data. However, the computational complexity of WFQ is very high. The computational cost for processing respective packets increases with the number of data flows. Thus, a great amount of scheduling computation will exhaust the system resources of a transmission device.

### SUMMARY

Block-based transmission scheduling methods and systems are provided.

In an embodiment of a block-based transmission scheduling method, a plurality of packets corresponding to at least one data flow is received. The packets of the data flow are accumulated to form a data block. Then, the data block of the data flow is scheduled and transmitted according to a transmission scheduling algorithm based on the unit of block.

An embodiment of a block-based transmission scheduling system at least includes a block accumulator and a scheduler. The block accumulator receives a plurality of packets corresponding to at least one data flow, and accumulates the packets of the data flow to form a data block. The scheduler is coupled to the block accumulator to receive the data block from the block accumulator, and schedules and transmits the data block of the data flow according to a transmission scheduling algorithm based on the unit of block.

Block-based transmission scheduling methods may take the form of a program code embodied in a tangible media. When the program code is loaded into and executed by a machine, the machine becomes an apparatus for practicing the disclosed method.

### BRIEF DESCRIPTION OF THE DRAWINGS

The disclosure will become more fully understood by referring to the following detailed description with reference to the accompanying drawings, wherein:

FIG. 1 is a schematic diagram illustrating an embodiment of a block-based transmission scheduling system of the present disclosure;

FIG. 2 is a flowchart of an embodiment of a block-based transmission scheduling method of the present disclosure;

FIG. 3 is a flowchart of an embodiment of a method for data block accumulation of the present disclosure;

FIG. 4 is a flowchart of another embodiment of a method for data block accumulation of the present disclosure;

FIG. 5 is a flowchart of further another embodiment of a method for data block accumulation of the present disclosure; and

FIG. 6 is a flowchart of an embodiment of a method for data block scheduling and transmission of the present disclosure.

### DETAILED DESCRIPTION

Block-based transmission scheduling methods and systems are provided.

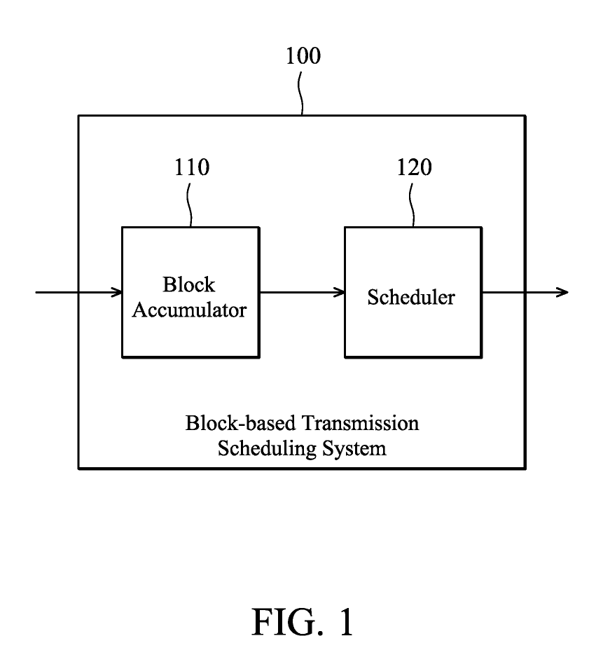

FIG. 1 is a schematic diagram illustrating an embodiment of a block-based transmission scheduling system of the present disclosure. The block-based transmission scheduling system 100 may be a processor-based electronic device, such as a high speed switch or a router. The block-based transmission scheduling system 100 comprises a block accumulator 110 and a scheduler 120. The block accumulator 110 can accumulate packets of respective data flow to form a data block. It is understood that, in some embodiments, the block accumulator 110 may have a plurality of accumulators respectively corresponding to various data flows, such that the received packets of the respective data flows can be accumulated in the corresponding accumulators. The data block accumulated by the block accumulator 110 can be provided to the scheduler 120 for subsequent scheduling and transmission operations. The details for the packet accumulation process of the block accumulator 110 will be discussed later. The scheduler 120 can schedule and transmit data blocks of respective data flows according to a transmission scheduling algorithm based on the unit of block. It is understood that, in some embodiments, the transmission scheduling algorithm may be WFQ, WF²Q (Worst-case Fair Weighted Fair Queuing), SCFQ (Self-Clocked Fair Queuing), or the virtual clock scheduling algorithm. It is noted that, the mentioned transmission scheduling algorithms are only examples of the present disclosure, and any transmission scheduling algorithm can be applied in the present disclosure. A detailed description for the scheduling and transmission process for the data blocks in the scheduler 120 will be discussed later. It is understood that, in some embodiments, the block-based transmission scheduling system 100 can further comprise a traffic regulator (not shown), which transmits the received packets to the block accumulator 110, to perform flow control for packets of respective data flows based on a token bucket mechanism. Similarly, in some embodiments, the traffic regulator may have a plurality of regulators respectively corresponding to various data flows, such that the flow control of packets of the respective data flows can be performed by the corresponding regulators.

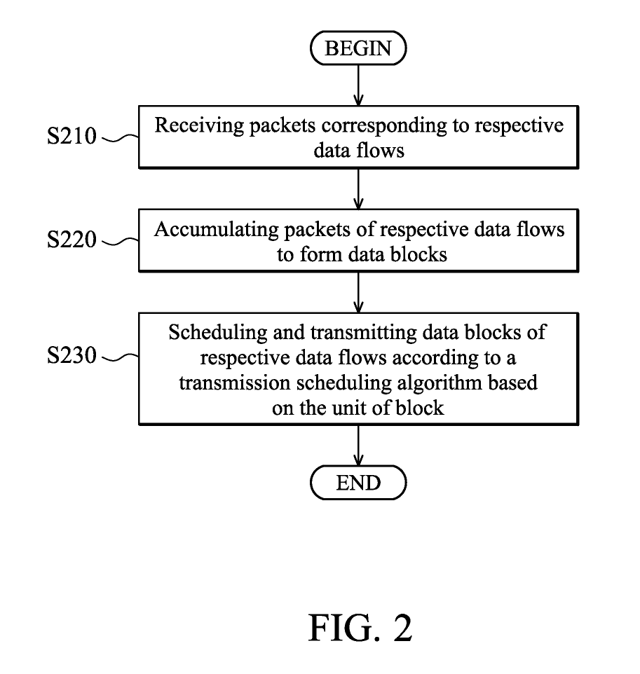

FIG. 2 is a flowchart of an embodiment of a block-based transmission scheduling method of the present disclosure. The block-based transmission scheduling method can be used in an electronic device, such as a high speed switch and router.

In step S210, a plurality of packets corresponding to at least one data flow is received. In step S220, the packets of the data flow are accumulated to form a data block. It is noted that, the block accumulator 110 can accumulate packets for respective data flows. Then, in step S230, the scheduler 120 schedules and transmits the data block of the data flow according to a transmission scheduling algorithm based on the unit of block.

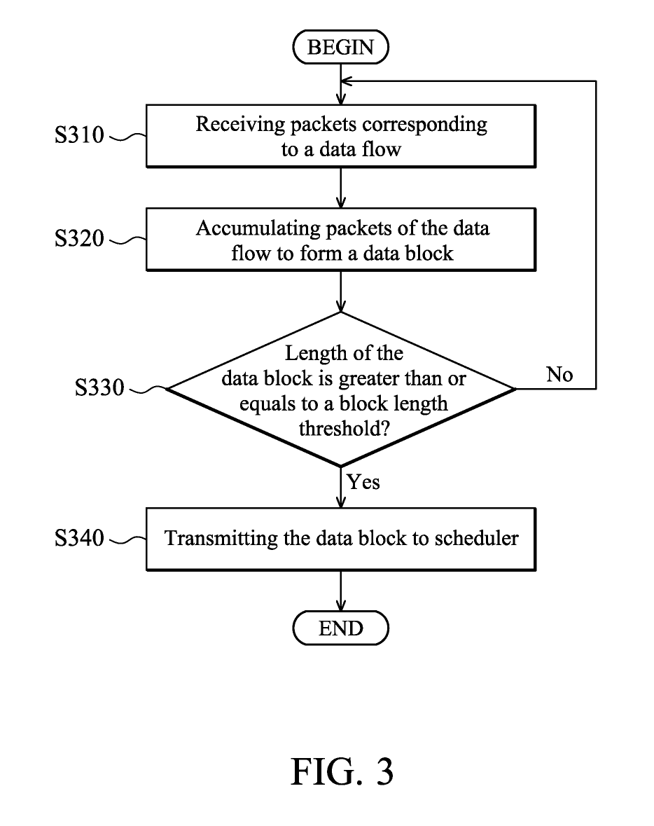

FIG. 3 is a flowchart of an embodiment of a method for data block accumulation of the present disclosure. As described, the block accumulator 110 can accumulate packets for respective data flows. In this embodiment, packet accumulation for a specific data flow is described.

In step S310, the block accumulator 110 receives a plurality of packets corresponding to a data flow. In step S320, the packets of the data flow are accumulated to form a data block. In step S330, it is determined whether the length of the accumulated data block is greater than or equals to a block length threshold. It is understood that, in some embodiments, the block length threshold can be a predefined value corresponding to the data flow. For example, in some embodiments, the block length threshold can equal to a maximum block length assigned to the data flow. Additionally, in some embodiments, the block length threshold can be dynamically calculated. For example, in some embodiments, the block length threshold can be calculated according to the maximum block size corresponding to the data flow, the length of a reference data block, such as the first data block of the data flow or a preceding data block of the accumulated data block, the scheduling time of the reference data block (the time the reference data block enters the scheduler), wherein the scheduling time is determined according to the transmission scheduling algorithm, and/or the state of a token bucket corresponding to the data flow at the time.

In an example, in which the transmission scheduling algorithm is WFQ, the block length threshold can be calculated according to the following formula:

Dᵢ=Bᵢ−max{0,σᵢ(t_{i,1})+b_{i,1}−σᵢ},

wherein Dᵢ the block length threshold of the accumulated data block corresponding to data flow i, Bᵢ the maximum block size corresponding to data flow i, t_{i,1} is the beginning time of the current busy period of data flow i in the scheduler, σᵢ(t_{i,1}) is the token quantity in the token bucket corresponding to data flow i at time t_{i,1}, b_{i,1} is the length of the first data block of data flow i in the current busy period, and σᵢ is the maximum burst data size of data flow i.

It is noted that, the above formula is an example of the present disclosure, and the block length threshold can be calculated according to various requirements and transmission scheduling algorithms. The present disclosure is not limited thereto.

When the length of the accumulated data block is less than the block length threshold (No in step S330), the procedure returns to step S310, and the block accumulator 110 continues to receive the packets corresponding to the data flow, and in step S320, the received packets are accumulated. When the length of the accumulated data block is greater than or equals to the block length threshold (Yes in step S330), in step S340, the block accumulator 110 transmits the data block to the scheduler 120. It is understood that, in some embodiments, when the length of the accumulated data block is greater than the block length threshold, the block accumulator 110 can adjust the accumulated data block, such that the length of the adjusted data block equals to a minimum value, which is not less than the block length threshold, or the length of the adjusted data block equals to a maximum value, which is not greater than the block length threshold. It is noted that, the remaining packets may be left in the block accumulator 110, to accumulate with subsequent packets, and be applied in the procedure in the embodiment of FIG. 3.

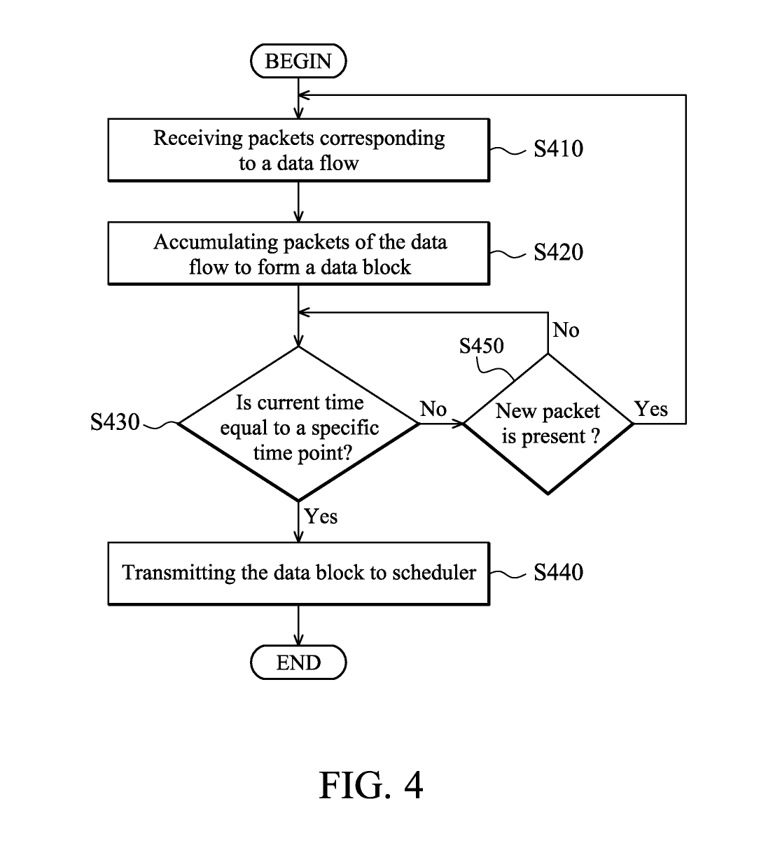

FIG. 4 is a flowchart of another embodiment of a method for data block accumulation of the present disclosure. As described, the block accumulator 110 can accumulate packets for respective data flows. In this embodiment, packet accumulation for a specific data flow is described.

In step S410, the block accumulator 110 receives a plurality of packets corresponding to a data flow. In step S420, the packets of the data flow are accumulated to form a data block. In step S430, it is determined whether current time is equal to a specific time point. It is understood that, in some embodiments, the period, which starts from the time the data block of the data flow is accumulated, to the specific time point, is a fixed duration corresponding to the data flow. Additionally, in some embodiments, the specific time point can be dynamically calculated according to a principle, in which the length of the data block and the accumulation duration are complementary. For example, in some embodiments, the specific time point can be dynamically calculated according to the length of the accumulated data block, the time at which the first packet in the data block of the data flow is received, the maximum block size corresponding to the data flow, and/or a promised bandwidth for the data flow. In an example, the specific time point can be calculated according to the following formula:

t_{i,k}=a_{i,k}(Bᵢ−b i,k)/rᵢ,

wherein t_{i,k} is the specific time point for the k-th block of data flow i, a_{i,k} is the time at which the first packet of the k-th block of data flow i arrived at the block accumulator, Bᵢ is the maximum block length corresponding to data flow i, b_{i,k} is the data length of the k-th block of data flow i, rᵢ=C·wᵢ/Σⱼ₌₁^{N}wⱼ is the promised bandwidth for data flow i, wherein wᵢ is the service weight of data flow i, and C is the total output bandwidth of the transmission system.

It is noted that, the above formula is an example of the present disclosure, and the specific time point can be calculated according to various requirements and applications. The present disclosure is not limited thereto.

When the specific time point is not present (No in step S430), in step S450, it is determined whether a new packet is present. If a new packet is present (Yes in step S450), the procedure returns to step S410, and the block accumulator 110 continues to receive the packet corresponding to the data flow, and in step S420, the received packets are accumulated. If no new packet is present (No in step S450), the procedure remains at step S430. When the current time is equal to the specific time point (Yes in step S430), in step S440, the block accumulator 110 transmits the data block to the scheduler 120.

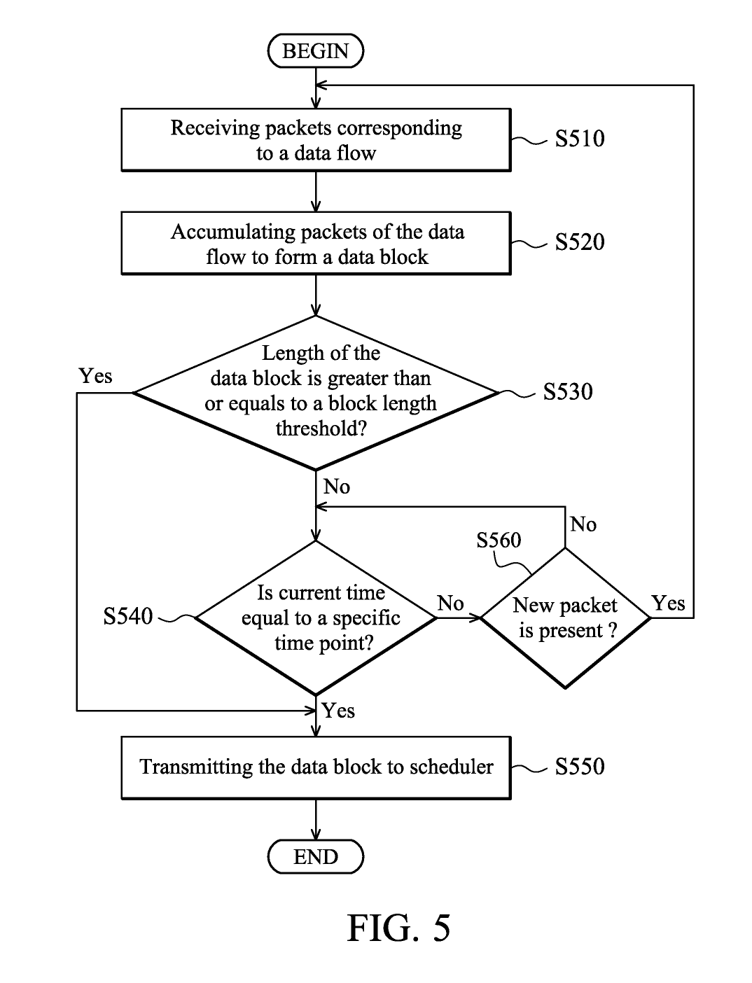

FIG. 5 is a flowchart of further another embodiment of a method for data block accumulation of the present disclosure. As described, the block accumulator 110 can accumulate packets for respective data flows. In this embodiment, packet accumulation for a specific data flow is described.

In step S510, the block accumulator 110 receives a plurality of packets corresponding to a data flow. In step S520, the packets of the data flow are accumulated to form a data block. In step S530, it is determined whether the length of the accumulated data block is greater than or equals to a block length threshold. Similarly, in some embodiments, the block length threshold can be a predefined value corresponding to the data flow. For example, in some embodiments, the block length threshold can equal to a maximum block size assigned to the data flow. In some embodiments, the block length threshold can be dynamically calculated. For example, in some embodiments, the block length threshold can be calculated according to the maximum block length corresponding to the data flow, the length of a reference data block, such as the first data block of the data flow or a preceding data block of the accumulated data block, the scheduling time of the reference data block (the time the reference data block enters the scheduler), wherein the scheduling time is determined according to the transmission scheduling algorithm, and/or the state of a token bucket corresponding to the data flow at the time. When the length of the accumulated data block is greater than or equals to the block length threshold (Yes in step S530), the procedure goes to step S550. When the length of the accumulated data block is not greater than and does not equal to the block length threshold (No in step S530), in step S540, it is determined whether current time is equal to a specific time point. Similarly, in some embodiments, the period, which starts from the time the data block of the data flow is accumulated, to the specific time point, is a fixed duration corresponding to the data flow. Additionally, in some embodiments, the specific time point can be dynamically calculated according to a principle, in which the length of the data block and the accumulation duration are complementary. For example, in some embodiments, the specific time point can be dynamically calculated according to the length of the accumulated data block, the time at which the first packet in the data block of the data flow is received, the maximum block size corresponding to the data flow, and/or a promised bandwidth for the data flow. When the specific time point is not present (No in step S540), in step S560, it is determined whether a new packet is present. If a new packet is present (Yes in step S560), the procedure returns to step S510, and the block accumulator 110 continues to receive the packet corresponding to the data flow, and in step S520, the received packets are accumulated. If no new packet is present (No in step S560), the procedure remains at step S540. When current time is equal to the specific time point (Yes in step S540), in step S550, the block accumulator 110 transmits the data block to the scheduler 120.

Similarly, in some embodiments, when the length of the accumulated data block is greater than the block length threshold (Yes in step S530), the block accumulator 110 can adjust the accumulated data block, such that the length of the adjusted data block equals to a minimum value, which is not less than the block length threshold, or the length of the adjusted data block equals to a maximum value, which is not greater than the block length threshold. It is noted that, the remaining packets may be left in the block accumulator 110, to accumulate with subsequent packets, and be applied in the procedure in the embodiment of FIG. 5.

After the scheduler 120 receives the data blocks corresponding to respective data flows from the block accumulator 110, the scheduler 120 can schedule and transmit the data blocks. In some embodiments, the data block corresponding to a respective data flow may have a service tag, and the service tag can be used to determine the service order of the respective data flow. In this embodiment, based on the service tags of the respective data flows, a specific data block having the highest service order can be selected from the data blocks corresponding to the respective data flows, and a packet can be obtained from the specific data block for transmission. After the packet obtained from the specific data block is transmitted, based on the service tags of the respective data flows, another specific data block having the highest service order can be selected from the data blocks corresponding to the respective data flows, and a packet is obtained from the selected specific data block for transmission. The scheduler 120 can repeat the procedure until all packets in the data blocks corresponding to the respective data flows are transmitted.

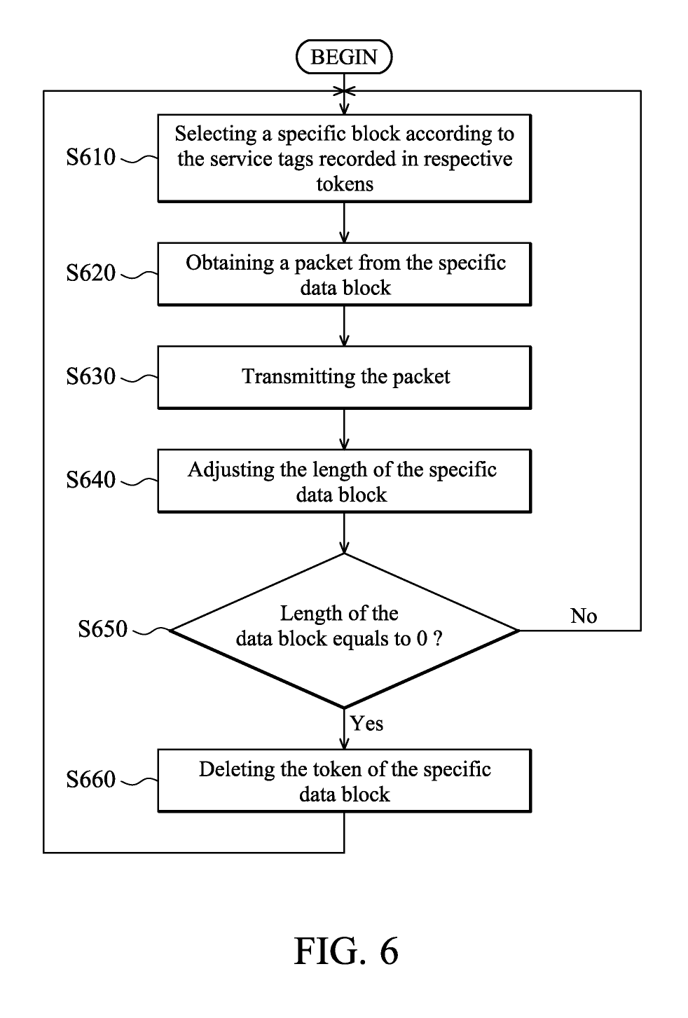

FIG. 6 is a flowchart of an embodiment of a method for data block scheduling and transmission of the present disclosure. It is understood that, after the scheduler 120 receives the data blocks corresponding to respective data flows from the block accumulator 110, the scheduler 120 can perform the embodiment of FIG. 6. In this embodiment, the data block of a respective data flow may correspond to a token, and the token may correspond to the first preceding data block corresponding to the data flow. Additionally, each data flow can have at most only one token which is sorted in the scheduler 120 at any time. The token can record the ID of the corresponding data flow, the length of the data block, and a service tag used to determine the service order of respective data flows.

In step S610, according to the service tags recorded in the respective tokens, a specific data block is selected from the data blocks corresponding to the respective data flows. It is noted that, the data block corresponding to the token having the highest service order, for example, the smallest value of the service tag is selected. It is understood that, in some embodiments, the scheduler 120 can have a token queue. The tokens in the token queue can be sorted based on the corresponding service tags. When the token having the highest service order becomes the first token in the token queue, the data block corresponding to the first token in the token queue will be selected. In step S620, a packet is obtained from the selected specific data block, and in step S630, the obtained packet is transmitted. After the packet is transmitted, in step S640, the length of the specific data block is adjusted to subtract the length of the transmitted packet from the length of the specific data block. In step S650, it is determined whether the adjusted length of the specific data block equals to 0 (that is, whether the number of packets in the specific data block equals to 0). When the adjusted length of the specific data block does not equal to 0 (No in step S650), the procedure returns to step S610, and according to the service tags recorded in the respective tokens, another specific data block is selected from the data blocks corresponding to the respective data flows, and subsequent operations are performed. When the adjusted length of the specific data block equals to 0 (Yes in step S650), in step S660, the token corresponding to the specific data block is deleted. It is noted that, if the scheduler 120 receives other data blocks of the data flow which the deleted token corresponds to, a token corresponding to the data flow is re-generated, and sorted with other tokens based on its service tag. The scheduler 120 will repetitively perform the embodiment of FIG. 6 until all packets in the respective data blocks are transmitted.

Therefore, the block-based transmission scheduling methods and systems can accumulate packets, and schedule and transmit data blocks based on the unit of block. In the present disclosure, since the packet-based transmission scheduling algorithm is transferred into the block-based transmission scheduling algorithm, the amount of calculations required by the scheduler can be reduced.

Block-based transmission scheduling methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A block-based transmission scheduling method for use in an electronic device, wherein the electronic device is programmed to perform the steps of:
receiving a plurality of packets corresponding to at least one data flow;
accumulating the packets of the data flow to form a data block; and
based on the unit of block, scheduling and transmitting the data block of the data flow according to a transmission scheduling algorithm.

2. The method of claim 1, further comprising:
determining whether the length of the accumulated data block is greater than or equals to a block length threshold; and
when the length of the accumulated data block is greater than or equals to the block length threshold, scheduling and transmitting the data block of the data flow according to the transmission scheduling algorithm based on the unit of block.

3. The method of claim 2, wherein when the length of the accumulated data block is greater than the block length threshold, the method further comprises a step of adjusting the accumulated data block, wherein the length of the adjusted data block equals to a minimum value, which is not less than the block length threshold, or the length of the adjusted data block equals to a maximum value, which is not greater than the block length threshold.

4. The method of claim 2, wherein the block length threshold is a predefined value corresponding to the data flow, or dynamically calculated according to a maximum block size corresponding to the data flow and the length of a reference data block of the data flow.

5. The method of claim 4, wherein the block length threshold is dynamically calculated further according to the scheduled time of the reference data block, wherein the scheduled time is determined according to the transmission scheduling algorithm, and the state of a token bucket corresponding to the data flow at the time.

6. The method of claim 1, further comprising:
determining whether current time is equal to a specific time point continuously; and
when current time is equal to the specific time point, scheduling and transmitting the data block of the data flow according to the transmission scheduling algorithm based on the unit of block.

7. The method of claim 6, wherein the period, which starts from the time the data block of the data flow is accumulated, to the specific time point, is a fixed duration corresponding to the data flow, or the specific time point is dynamically calculated according to the length of the accumulated data block.

8. The method of claim 7, wherein the specific time point is dynamically calculated further according to the time at which the first packet in the data block corresponding to the data flow is received, a maximum block size corresponding to the data flow, and a promised bandwidth for the data flow.

9. The method of claim 6, wherein when current time is not equal to the specific time point, the method further comprises the steps of:
determining whether a new packet is present; and
when a new packet is present, receiving and accumulating the new packet into the data block.

10. The method of claim 1, wherein a service tag is provided to each of the at least one data flow, the service tag is used to determine the service order of the at least one data flow, and the method of scheduling and transmitting the data blocks of the corresponding data flows according to the transmission scheduling algorithm comprises the steps of:
according to the service tag of each data flow, selecting a first specific data block among data blocks corresponding to the respective data flows, and obtaining a packet from the first specific data block for transmission; and
according to the service tag of each data flow, selecting a second specific data block among the data blocks corresponding to the respective data flows, and obtaining a packet from the second specific data block for transmission.

11. The method of claim 1, further comprising:
determining whether the length of the accumulated data block is greater than or equals to a block length threshold;
when the length of the accumulated data block is greater than or equals to the block length threshold, scheduling and transmitting the data block of the data flow according to the transmission scheduling algorithm based on the unit of block;
determining whether current time is equal to a specific time point continuously; and
when current time is equal to the specific time point, scheduling and transmitting the data block of the data flow according to the transmission scheduling algorithm based on the unit of block.

12. The method of claim 11, wherein when current time is not equal to the specific time point, the method further comprises the steps of:
determining whether a new packet is present; and
when a new packet is present, receiving and accumulating the new packet into the data block.

13. A block-based transmission scheduling system, comprising:
a block accumulator receiving a plurality of packets corresponding to at least one data flow, and accumulating the packets of the data flow to form a data block; and
a scheduler coupled to the block accumulator to receive the data block, scheduling and transmitting the data block of the data flow according to a transmission scheduling algorithm based on the unit of block.

14. The system of claim 13, wherein the block accumulator further determines whether the length of the accumulated data block is greater than or equals to a block length threshold, and transmits the data block to the scheduler when the length of the accumulated data block is greater than or equals to the block length threshold.

15. The system of claim 14, wherein when the length of the accumulated data block is greater than the block length threshold, the block accumulator further adjusts the accumulated data block, wherein the length of the adjusted data block equals to a minimum value, which is not less than the block length threshold, or the length of the adjusted data block equals to a maximum value, which is not greater than the block length threshold.

16. The system of claim 14, wherein the block length threshold is a predefined value corresponding to the data flow, or dynamically calculated according to a maximum block size corresponding to the data flow and the length of a reference data block of the data flow.

17. The system of claim 16, wherein the block length threshold is dynamically calculated further according to the scheduled time of the reference data block, wherein the scheduled time is determined according to the transmission scheduling algorithm, and the state of a token bucket corresponding to the data flow at the time.

18. The system of claim 13, wherein the block accumulator further continuously determines whether current time is equal to a specific time point, and transmits the data block of the data flow to the scheduler when current time is equal to the specific time point.

19. The system of claim 18, wherein the period, which starts from the time the data block of the data flow is accumulated, to the specific time point, is a fixed duration corresponding to the data flow, or the specific time point is dynamically calculated according to the length of the accumulated data block.

20. The system of claim 19, wherein the specific time point is dynamically calculated further according to the time at which the first packet in the data block corresponding to the data flow is received, a maximum block size corresponding to the data flow, and a promised bandwidth for the data flow.

21. The system of claim 18, wherein when current time is not equal to the specific time point, the block accumulator further determines whether a new packet is present, and when a new packet is present, receives and accumulates the new packet into the data block.

22. The system of claim 13, wherein a service tag is provided to each of the at least one data flow, the service tag is used to determine the service order of the at least one data flow, and the scheduler selects a first specific data block among data blocks corresponding to the respective data flows according to the service tag of each data flow, obtains a packet from the first specific data block for transmission, selects a second specific data block among the data blocks corresponding to the respective data flows according to the service tag of each data flow, and obtains a packet from the second specific data block for transmission.

23. The system of claim 13, wherein the block accumulator further determines whether the length of the accumulated data block is greater than or equals to a block length threshold, transmits the data block to the scheduler when the length of the accumulated data block is greater than or equals to the block length threshold, continuously determines whether current time is equal to a specific time point, and transmits the data block to the scheduler when current time is equal to the specific time point.

24. The system of claim 23, wherein when current time is not equal to the specific time point, the block accumulator further determines whether a new packet is present, and when a new packet is present, receives and accumulates the new packet into the data block.

25. A machine-readable storage medium comprising a computer program, which, when executed, causes a device to perform a block-based transmission scheduling, and the method comprises:
receiving a plurality of packets corresponding to at least one data flow;
accumulating the packets of the data flow to form a data block; and
based on the unit of block, scheduling and transmitting the data block of the data flow according to a transmission scheduling algorithm.
